(19) United States
(12) Patent Application Publication
(10) Pub. No.: US 2010/0219166 A1
(43) Pub. Date: Sep. 2, 2010

(54) HOLE-FORMING MACHINE

(75) Inventors: Takashi Kobayashi, Tochigi (JP); Masahiro Tezuka, Tochigi (JP); Hiroaki Yamagishi, Tochigi (JP); Hiroshi Kashiwagi, Tochigi (JP); Minoru Iga, Tochigi (JP)

Correspondence Address: ARENT FOX LLP, 1050 CONNECTICUT AVENUE, N.W., SUITE 400, WASHINGTON, DC, 20036, US

(73) Assignee: HONDA MOTOR CO., LTD., Tokyo (JP)

(21) Appl. No.: 12/715,295

(22) Filed: Mar. 1, 2010

(30) Foreign Application Priority Data
Mar. 2, 2009 (JP) P2009-048312
Mar. 2, 2009 (JP) P2009-048336

(51) Int. Cl. B23K 26/38

(52) U.S. Cl. 219/121.7

(57) ABSTRACT

A hole-forming machine for forming a through-hole (75) in a workpiece (66) by directing laser light (70) from the exterior of the workpiece into a hollow part (67). The machine includes a vibrating mechanism (56) for causing vibration in a filler (65) which fills the hollow part of the workpiece (66) and which is not melted by the laser light, the vibrating mechanism being disposed so as to be in contact with the filler.

### FIELD OF THE INVENTION

The present invention relates to a hole-forming machine for forming a through-hole in a wall of a workpiece by irradiation with laser light.

### BACKGROUND OF THE INVENTION

For example, when a fuel injection nozzle is manufactured, hole formation is performed by irradiation with laser light in a wall in order to form a through-hole. After the hole has been opened in the wall, when the laser light passes through the through-hole and reaches the internal peripheral surface of the fuel injection nozzle, the internal peripheral surface is cut despite not needing to be cut. Thus, techniques for preventing the internal peripheral surface from being cut by the laser light are known, such as the technique disclosed in International Publication WO99/11419.

According to International Publication WO99/11419, a fluid is disposed in the distal end of the fuel injection nozzle, and cavitation is induced therein, whereby the laser light is scattered. It is thereby possible to prevent the internal peripheral surface from being cut by the laser light.

However, even in cases in which the laser light is scattered, some of the scattered laser light still sometimes reaches the internal peripheral surface. The internal peripheral surface could possibly be damaged by the laser light in cases of a strong laser light output.

In view of this, there is a demand for a hole-forming machine whereby laser light can be more precisely prevented from being directed onto the internal peripheral surface.

### SUMMARY OF THE INVENTION

It is therefore an object of the present invention to provide a hole-forming machine whereby laser light can be more precisely prevented from being directed onto the internal peripheral surface.

According to an aspect of the present invention, there is provided a hole-forming machine for directing laser light from an exterior of a hollow workpiece into a hollow part of the workpiece to thereby form a through-hole in a wall of the workpiece, which machine comprises: a filler being unmeltable by the laser light and filled in the hollow part; a vibrating mechanism disposed to be in contact with the filler for causing the filler to vibrate; pressure-reducing means connected with the hollow part for making an air pressure in the hollow part less than that outside the wall; an irradiation chamber formed in such a manner as to close the irradiation part for leading the laser light into a part of the workpiece to be irradiated with the laser light; gas supply means connected with the irradiation chamber for supplying compressed gas into the irradiation chamber; expulsion means, having a distal end extending into the irradiation chamber, for expelling gas in the irradiation chamber, including dust created by the laser light irradiation, to outside of the irradiation chamber; and a control device for controlling the vibrating mechanism, the low-pressure means, the gas supply means and the expulsion means.

The filler which is not melted by the laser light is loaded in the hollow part. Thus, the laser light that has formed the through-hole collides with the filler filling the hollow part. The filler absorbs the energy of the laser light via this collision. The laser light can be prevented from being directed onto the internal peripheral surface due to the filler absorbing this energy.

Preferably, the workpiece is turnably supported by a workpiece-rotating table having a rotational axis that passes through the workpiece. In other words, the workpiece is disposed along the rotational axis. The angle of the workpiece relative to the incoming laser light can thereby be changed by turning the workpiece-rotating table. Specifically, it is possible to form holes from many different angles with a single machine, which is effective.

Desirably, the control device is designed to control the air pressure in the irradiation chamber such that the air pressure is greater than the air pressure in the hollow part and equal to or less than atmospheric pressure until the through-hole is formed. Consequently, an air flow is created through the irradiation chamber by creating this difference in air pressure. Dust is efficiently expelled to the exterior by this air flow.

In a preferred form, the control device control the expulsion means so as to stop the expulsion function after the through-hole has been formed. In other words, it is possible to efficiently expel dust to the exterior by creating a single air flow for expelling the dust.

It is preferred that the filler have a diameter of 30 μm to 20 mm, the vibrating mechanism vibrate at a vibration frequency of 30 hKz to 100 kHz, and the amplitude of the vibration frequency be 5 μm to 30 μm. If the filler is this size, a space sufficient for vibrating the filler is formed in the hollow part. Inducing vibration under these conditions makes it possible to prolong the life of the filler because the filler can be made to vibrate efficiently.

According to another aspect of the present invention, there is provided a hole-forming machine for directing laser light from an exterior of a hollow workpiece into a hollow part of the workpiece to thereby form a through-hole in a wall of the workpiece, which machine comprises: a filler being unmeltable by the laser light and filled in the hollow part; a vibrating mechanism disposed to be in contact with the filler for causing the filler to vibrate; and a workpiece-clamping mechanism for securing the workpiece in place.

Consequently, the laser light that has formed a hole in the wall collides with the filler filled in the hollow part. The filler thereby absorbs the energy of the laser light. Therefore, the laser light can be prevented from being directed onto the internal peripheral surface of the hollow workpiece.

Preferably, the machine further comprises low-pressure means for making the air pressure in the hollow part lower than that outside the wall, the low-pressure means being joined to the hollow part. The air pressure in the hollow part is reduced to be lower than that outside the wall by the low-pressure means. A tensile force thereby acts to draw the workpiece toward the lower pressure. Before the hole is formed, the workpiece is firmly held in place by this force. After the hole is formed, the dust created by the laser light irradiation is recovered by this force, and dust does not accumulate in the vicinity of the hole. It is thereby possible to prevent dust from re-adhering in the vicinity of the hole, and to make the operation more efficient.

### BRIEF DESCRIPTION OF THE DRAWINGS

Certain preferred embodiments of the present invention will be described in detail below, by way of example only, with reference to the accompanying drawings, in which:

FIG. 1 is a schematic view illustrating an overall configuration of a hole-forming machine according to an embodiment of the present invention;

FIG. 2 is a cross-sectional view showing a workpiece-supporting member shown in FIG. 1;

FIG. 3 are schematic views showing a manner in which the workpiece is set on the workpiece-supporting member;

FIG. 4 are schematic views showing the workpiece being clamped in the work position;

FIG. 5 is a cross-sectional view showing details of the workpiece in a clamped state;

FIG. 6 is a cross-sectional view taken along line 6-6 of FIG. 5;

FIG. 7 are schematic views showing a change in an angle of irradiation of the laser on the workpiece;

FIG. 8 are schematic views showing comparisons between the inventive arrangement and example arrangements with no expulsion means and filler used; and

FIG. 9 is a schematic view showing an alteration of the clamp mechanism of FIG. 2.

### DETAILED DESCRIPTION OF THE PREFERRED EMBODIMENTS

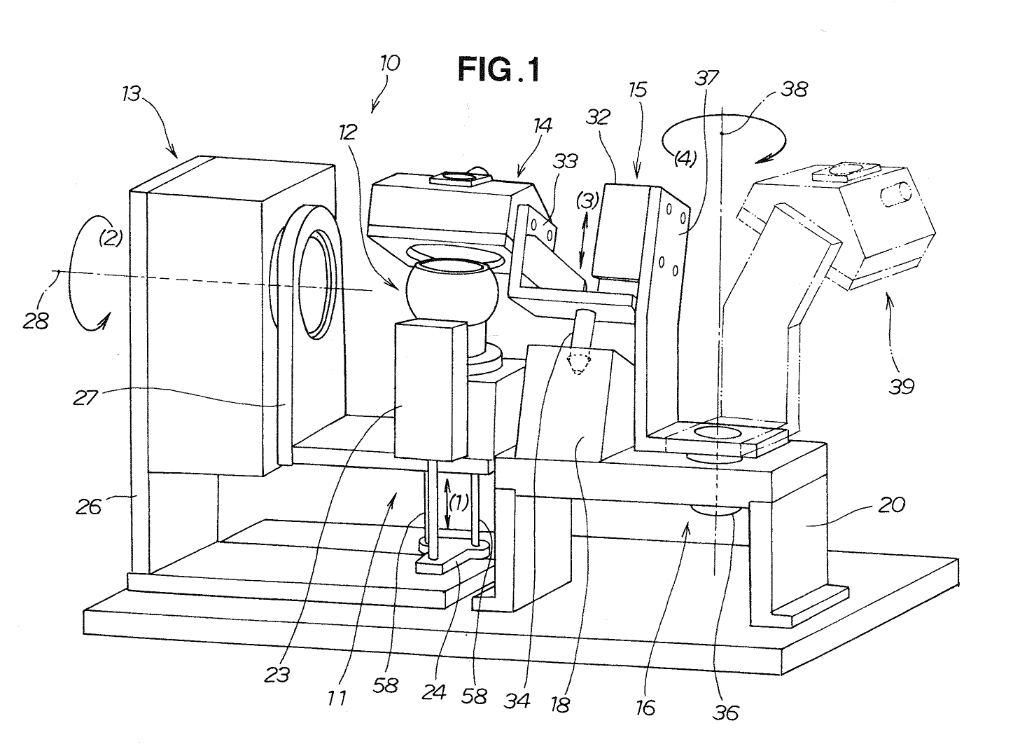

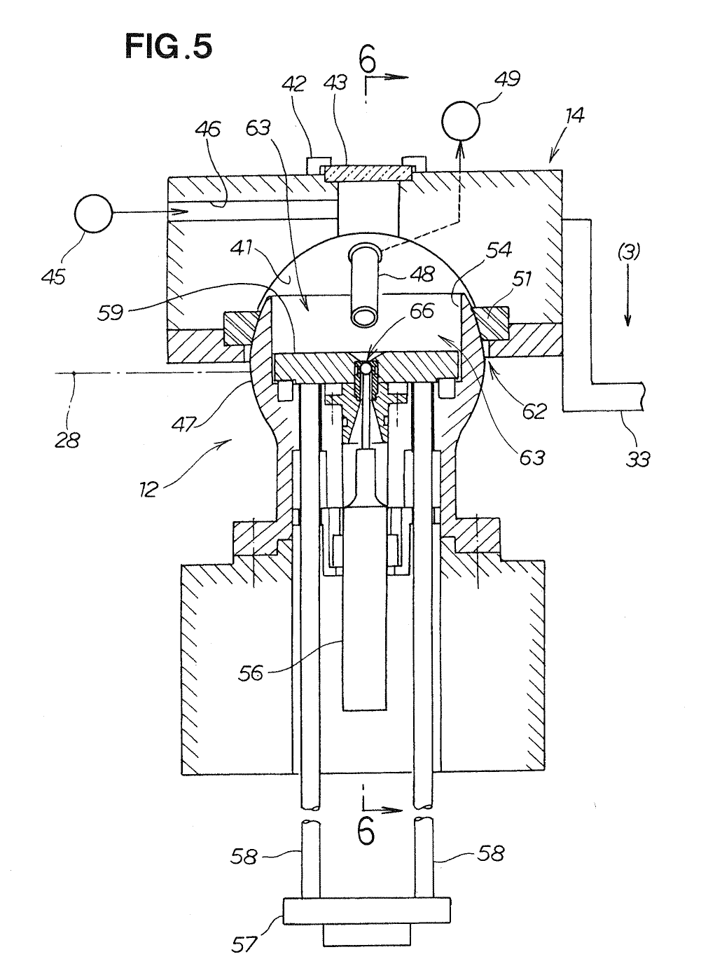

Referring to FIG. 1, a hole-forming machine 10 comprises a workpiece-clamping mechanism 11 for clamping a workpiece 66 (see FIG. 5), a workpiece-supporting member 12 for supporting the workpiece clamped by the workpiece-clamping mechanism 11, a workpiece-rotating mechanism 13 for rotatably supporting the workpiece-supporting member 12 and turning the workpiece, a raising/lowering mechanism 15 for raising and lowering a lid 14 which covers the workpiece-supporting member 12, a lid-rotating mechanism 16 for integrally rotating the raising/lowering mechanism 15 and the lid 14, a positioning block 18 for positioning the lid 14, and a work stand 20 for supporting the positioning block 18 and the lid-rotating mechanism 16.

In the workpiece-clamping mechanism 11, a plate 24 is connected to the distal end of a clamp cylinder 23; actuating the clamp cylinder 23 raises and lowers the plate 24 as shown by the arrow (1). The clamping and releasing of the workpiece is thereby operated.

As is described in detail hereinafter, a workpiece placed in the workpiece-supporting member 12 is clamped in the state shown in FIG. 1. From here the clamp cylinder 23 is actuated and the plate 24 is raised, thereby releasing the clamp.

The workpiece-rotating mechanism 13 is composed of a rotating mechanism support 26, and an L-shaped workpiece-rotating table 27 for supporting the workpiece-supporting member 12, the table being rotatably supported by the rotating mechanism support 26.

The workpiece-rotating table 27 turns about a rotational axis 28 as shown by the arrow (2). The rotational axis 28 meets the workpiece supported in the workpiece-supporting member 12. In other words, the workpiece is disposed along the rotational axis 28 of the workpiece-rotating table 27.

In the raising/lowering mechanism 15, actuating a lid-raising/lowering cylinder 32 up and down as shown by the arrow (3) integrally raises and lowers the lid 14, a lid support 33 for supporting the lid 14, and a positioning pin 34 disposed on the bottom side of the lid support 33.

From the state shown in FIG. 1, the lid-raising/lowering cylinder 32 is actuated, and the lid 14, the lid support 33, and the positioning pin 34 are lowered. The lid 14 covers the workpiece-supporting member 12, and the positioning pin 34 is inserted into a positioning block 18.

The lid-rotating mechanism 16 is composed of a lid-rotating motor 36 for rotating the lid 14 horizontally, and a support brace 37 for supporting the lid-raising/lowering cylinder 32, the brace being disposed on the top side of the lid-rotating motor 36.

Actuating the lid-rotating motor 36 causes the support brace 37 to rotate about a rotational axis 38 as shown by the arrow (4). This causes the lid-raising/lowering cylinder 32, the lid support 33, the lid 14, and the positioning pin 34 supported by the support brace 37 to turn integrally.

For example, when the workpiece-rotating table 27 is actuated (arrow (2)), the clamp cylinder 23 must be prevented from coming in contact with the lid 14. In such cases, the lid 14 and the other components are moved out of the way to a standby position 39 shown by the faint lines.

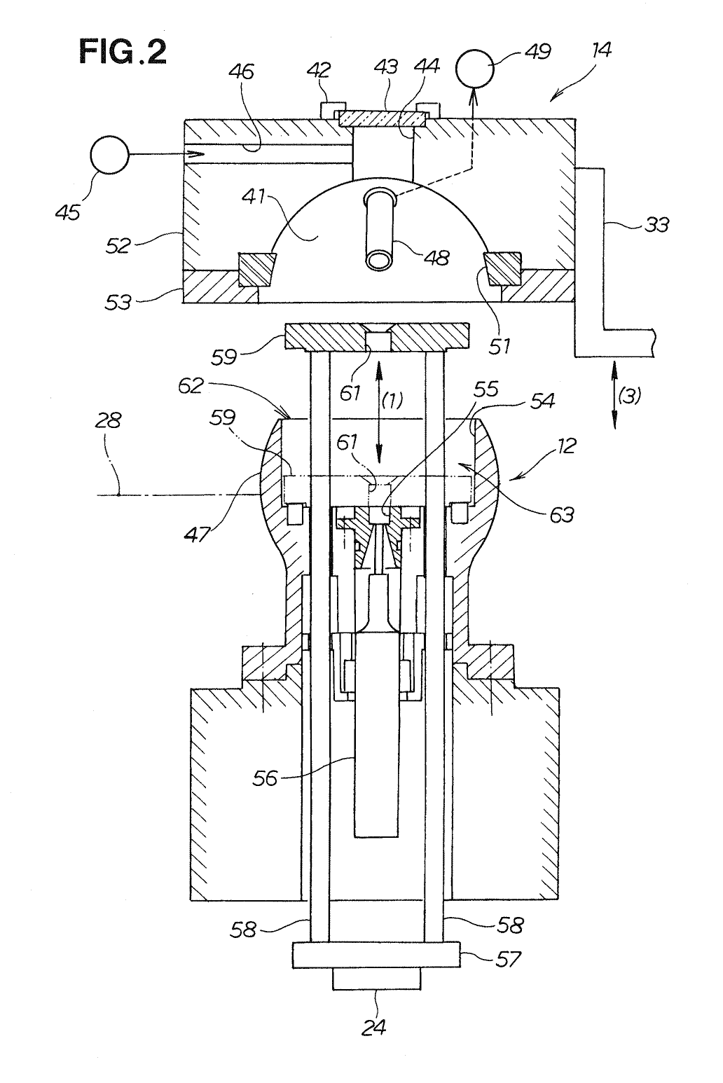

The lid 14 comprises a transparent plate 43 supported on a topside support frame 42 and permeated by laser light, and a pathway 44 through which laser light passes after passing through the transparent plate 43, as shown in FIG. 2. The pathway 44 opens through a dividing wall 41 which forms the space of an irradiation chamber 63 for accommodating the workpiece irradiated by the laser light passing through the pathway 44. Furthermore, the lid 14 comprises a compressed gas supply channel 46 which joins the pathway 44 and allows the passage of compressed gas supplied from gas supply means 45, a distal end part 48 formed into a nozzle shape and oriented of necessity in the direction in which laser light is directed, expulsion means 49 for drawing in dust produced by the laser light irradiation from the distal end part 48, and a seal member 51 which comes in contact with the workpiece-supporting member 12 when the workpiece-supporting member 12 is covered by the lid 14.

The dust produced by the laser light irradiation is a metal vapor or an ionized mixed gas referred to as a plume, and is the result of the metal on the surface of the workpiece being evaporated by heat during laser machining. The arrows (1) and (3) are the same as the arrows (1) and (3) in FIG. 1.

The lid 14 is configured from a top base 52 and a bottom base 53, and the seal member 51 is disposed so as to be sandwiched between the top base 52 and the bottom base 53. The gas supplied from the gas supply means 45 can be air, or nitrogen or another inert gas, and any type of compressed gas can be used.

The workpiece-supporting member 12 is composed of an outside wall 47 which comes in contact with the seal member 51, a concave part 62 having an inside wall 54 forming the space of the irradiation chamber 63 in a position opposite the dividing wall 41, a first workpiece pocket 55 on which the workpiece rests in the bottom of the concave part 62, a vibrating mechanism 56 which uses an ultrasonic vibrator whose distal end extends toward the first workpiece pocket 55, and low-pressure means (described in detail hereinafter) for reducing the pressure in the bottom of the first workpiece pocket 55, the low-pressure means being joined in proximity to the distal end of the vibrating mechanism 56.

Lowering the plate 24 causes a support plate 57, support braces 58, 58, and a clamp plate 59 connected to the plate 24 to be integrally lowered. The workpiece is clamped by the first workpiece pocket 55 and a second workpiece pocket 61 formed in the bottom side of the clamp plate 59 as shown by the faint lines.

The lid 14 is then lowered over the workpiece-supporting member 12 as shown by the arrow (3). The area enclosed by the lid 14 and the workpiece-supporting member 12 at this time is the irradiation chamber 63 in which laser light is directed. In other words, it can be said that the gas supply means 45 joins to the irradiation chamber 63 and supplies compressed gas into the irradiation chamber 63. It can also be said that the distal end part 48 of the expulsion means 49, which is formed into a nozzle shape, extends into the irradiation chamber 63.

The setting of the workpiece is described in the next drawing.

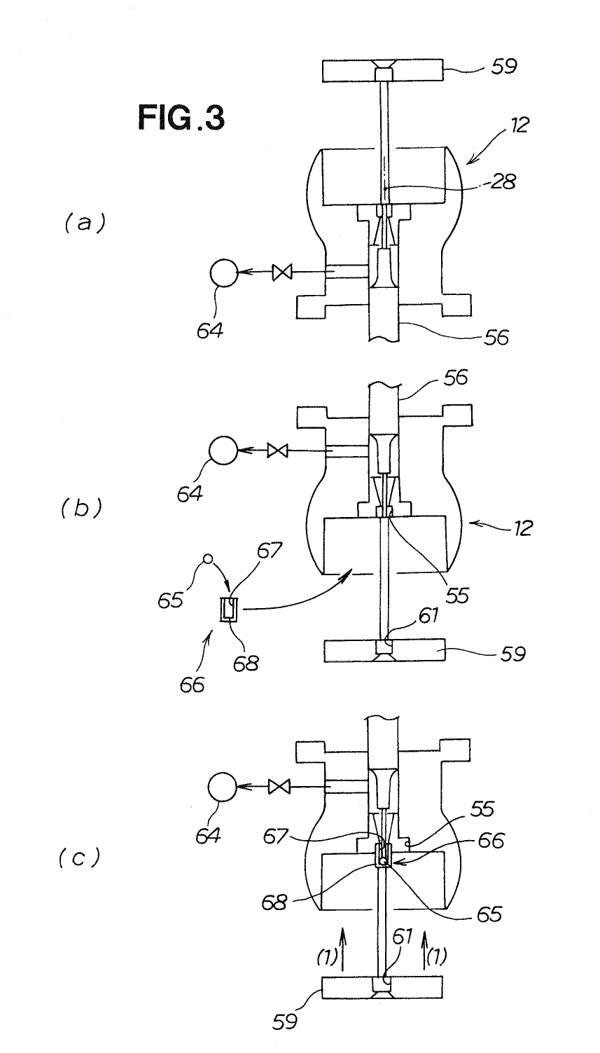

From a state of the distal end of the vibrating mechanism 56 pointing upward as shown in FIG. 3(a), the workpiece-rotating table 27 (1) is actuated and the workpiece-supporting member 12 is rotated to the state shown in FIG. 3(b), in which the distal end of the vibrating mechanism 56 points downward.

In FIG. 3, the workpiece-supporting member 12 is seen from the direction in which the rotational axis 28 extends front to back in the drawing.

Next, in the state shown in FIG. 3(b), a low-pressure means 64 is actuated for reducing the pressure in the side of the first workpiece pocket 55 facing the vibrating mechanism 56. Using a ball of zirconia which is not melted by the laser light as a filler 65, a hollow part 67 of the workpiece 66 is filled and the workpiece is placed in the first workpiece pocket 55.

At this time, the action of the low-pressure means 64 causes an upward tensile force to act on the workpiece 66. Consequently, the workpiece 66 does not fall even if there is no one holding on to the workpiece 66 before it is clamped by the clamp plate 59.

The zirconia ball used as the filler 65 is made of zirconia, which is an oxide ceramic. Zirconia, as is conventionally known, has an extremely high melting point and therefore does not melt even if exposed to laser light. The location in the filler 65 exposed to laser light is fragmented. As a result, a fine powder is created.

Powder can also be used as the filler instead of a zirconia ball. The diameter of the filler 65 including the zirconia powder is set based on the duration of laser light irradiation and the oscillation frequency. In other words, the radius R of the minimum necessary filler is expressed by the following equation (1), wherein V₀ is the volume of the zirconia filler 65 before being irradiated with laser light, Z is the volume fragmented with each pulse, f is the oscillation frequency of the laser light, and t is the time duration of laser light irradiation.

R={3V₀−tfZ/4π}^{1/3} (1)

In other words, the filler 65 selected is one that has a radius greater than the radius R derived from Equation (1). The volume Z fragmented with each pulse in Equation (1) is a volume found in advance through experimentation, and therefore a filler other than one including zirconia power can be selected as long as the volume Z fragmented with each pulse can be found in advance through experimentation, even if the filler material is zirconia, for example.

While laser light is being directed onto the workpiece, a through-hole is formed in the wall of the workpiece, and the filler 65 is provided to prevent the laser light passing through the through-hole from reaching the internal peripheral surface of the workpiece which faces the wall in which the through-hole is formed. The material and shape of the filler is not particularly limited as long as it does not melt under irradiation by laser light and the radius is greater than both the diameter of the through-hole formed in the workpiece and the radius R derived from Equation (1) above.

The diameter of the through-hole is 3 μm to 200 μm, and a powder at least larger than the through-hole must be used. In the case that a zirconia ball is used, the diameter of the zirconia ball is preferably 30 μm to 20 mm.

Next, the clamp plate 59 is raised as shown by the arrow (1) in FIG. 3(c), and the workpiece 66 is clamped. The setting of the workpiece 66 is thereby complete.

As shown in this drawing, the low-pressure means 64 joins with the hollow part 67 and reduces the air pressure in the hollow part 67 to be less than the outside of the wall 68.

The air pressure in the hollow part 67 is reduced to less than the outside of the wall 68 by the low-pressure means 64. A tensile force thereby acts to draw the workpiece 66 toward the low pressure area. Before a hole is formed, the workpiece 66 is held firmly in place by this force.

Moving the workpiece-supporting member to the work position will be described in the next drawing.

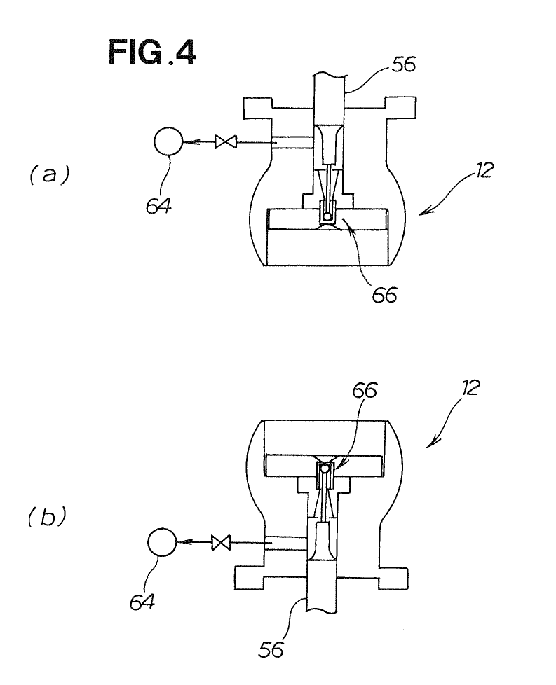

After the workpiece 66 is clamped as shown in FIG. 4(a), the workpiece-rotating table 27 (FIG. 1) is actuated and the workpiece-supporting member 12 is moved to a position such that the distal end of the vibrating mechanism 56 again points upward as shown in FIG. 4(b).

The action of covering the workpiece-supporting member 12 with the lid 14 is described in the next drawing.

The lid 14 is moved above the workpiece-supporting member 12 from the standby position 39 (FIG. 1) as shown in FIG. 5, and the lid 14 is then lowered as shown by the arrow (3). This action causes the irradiation chamber 63 to be formed by the dividing wall 41 of the lid 14, the seal member 51, and the inside wall 54 and clamp plate 59 of the workpiece-supporting member 12. With the irradiation chamber 63 formed in this manner, the workpiece is irradiated with laser light.

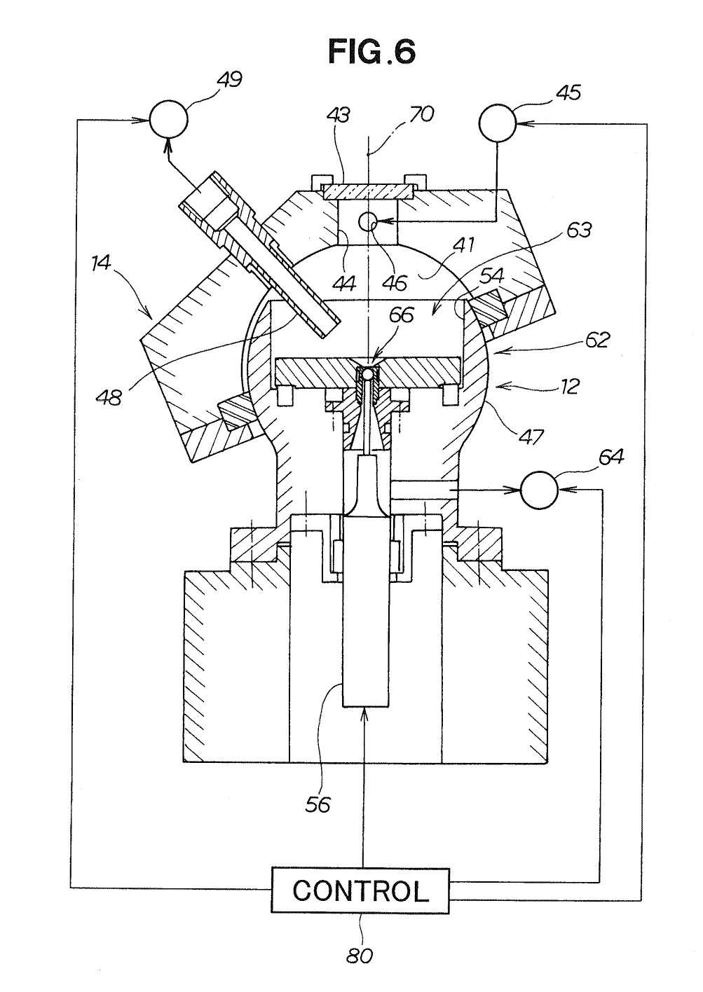

When the laser light 70 is directed as shown in FIG. 6, compressed gas is supplied by the gas supply means 45 while dust created by the laser light 70 irradiation is expelled by the expulsion means 49. The air pressure in the irradiation chamber 63 is increased by the supply of compressed gas by the gas supply means 45. Therefore, an air pressure equal to atmospheric pressure can be maintained inside the irradiation chamber 63 by actuating the expulsion means 49.

The vibrating mechanism 56, the low-pressure means 64, the gas supply means 45, and the expulsion means 49 are all controlled and actuated by a control device 80 to which they are connected.

Nanosecond laser light or picosecond laser light can be used for the laser light. Both a nanosecond laser light irradiation device and a picosecond laser light irradiation device can be supported in the laser machining head. In this case, high-precision hole-forming work can be performed in a short amount of time by performing general hole-forming with nanosecond laser light, and then performing finishing with picosecond laser light.

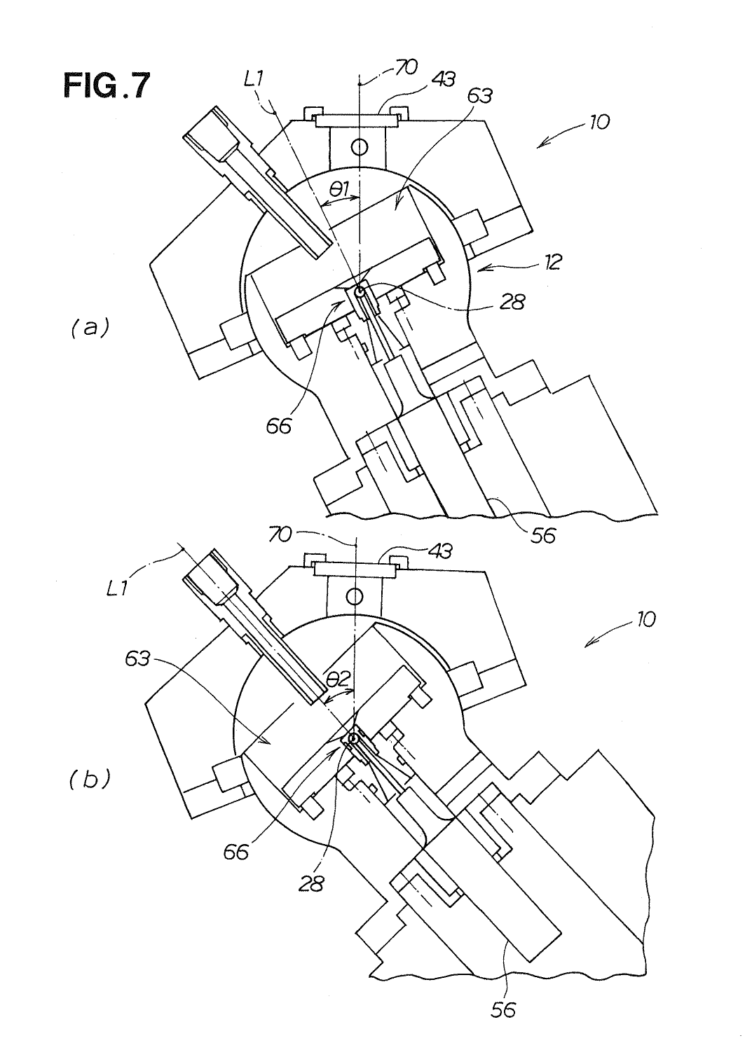

The angle θ formed by the axis L1 of the vibrating mechanism 56 relative to the laser light 70 can be changed by rotating the workpiece-rotating table 27 (FIG. 1), as shown in FIG. 7(a). For example, θ1 in the case in FIG. 7(a) is 27°, and this angle can be changed to an angle θ2 of 45° as shown in FIG. 7(b) by rotation. The irradiation angle whereby the laser light 70 strikes the workpiece 66 can thereby be changed.

The workpiece 66 is disposed along the rotational axis 28 extending in the front to back direction of the drawing. The angle of the workpiece 66 relative to the incoming laser light 70 can thereby be changed by rotating the workpiece-rotating table. In other words, holes can be formed from various angles in a single machine, which is effective.

In cases in which the workpiece 66 is placed away from the rotational axis 28, the workpiece 66 is moved a large amount by rotating the workpiece-supporting member 12, and the workpiece 66 moves to a position where it is not irradiated by the laser light 70. Conversely, it can be said that the hole-forming machine 10 of the present invention is a hole-forming machine in which the workpiece 66 is disposed along the rotational axis 28, whereby the irradiation angle of the laser light 70 can be changed with a simple configuration.

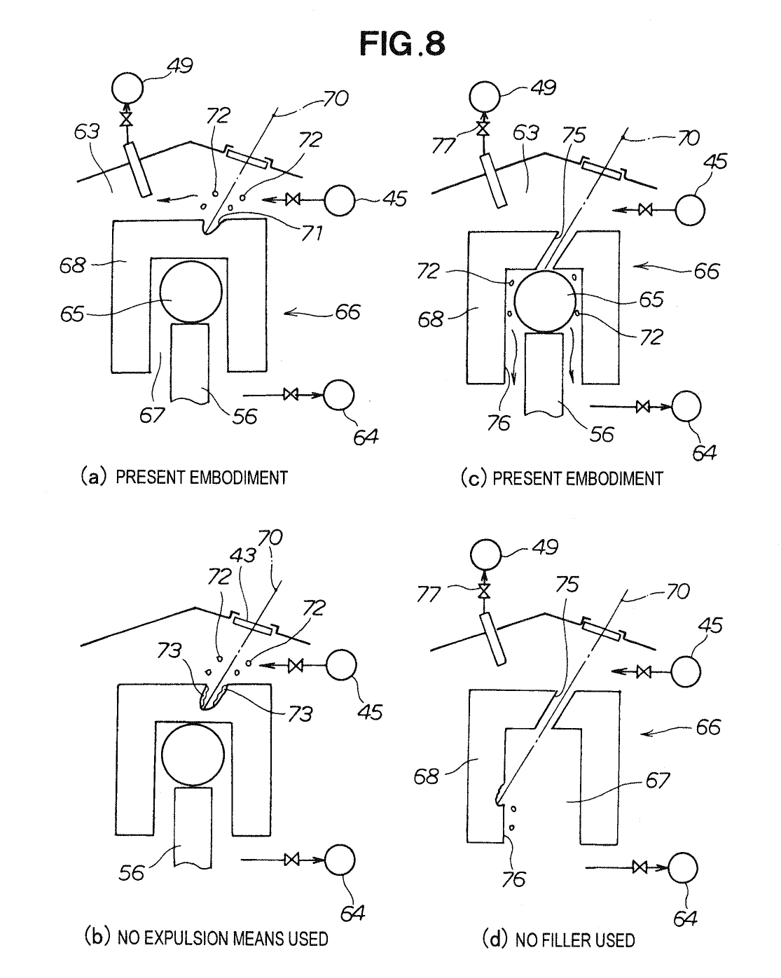

The dust 72 created in an irradiated area 71 can be quickly recovered by irradiating the workpiece 66 with the laser light 70 while actuating the expulsion means 49, as shown in FIG. 8(a). Until the through-hole 75 shown in FIG. 8(c) is formed, the control device 80 (FIG. 6) controls the air pressure in the irradiation chamber 63 so as to be higher than the air pressure in the hollow part 67 and equal to or less than the atmospheric pressure.

In other words, the control device 80 controls the expulsion means 49 so as to suction out a greater amount than the amount of gas supplied per unit time by the gas supply means 45. In addition, the control device 80 controls the low-pressure means 64 so as to suction out a greater amount than the amount suctioned out per unit time by the expulsion means 49. An air flow into the irradiation chamber 63 is created by creating a difference in air pressure. The dust is efficiently expelled to the exterior by this air flow.

In a comparative example which has no expulsion means as shown in FIG. 8(b), the vaporized dust 72 stops where the expulsion means would be and thus sometimes re-adheres in the hole. Consequently, more time is required because the hole is formed while the re-adhered dust 73 is scraped off. Specifically, by irradiating the workpiece 66 with laser light 70 while actuating the expulsion means 49 as shown in FIG. 8(a), the dust 72 can be prevented from re-adhering and can be quickly passed through the hole.

In other words, the hole-forming machine includes a control device 80 (FIG. 6), and the irradiation chamber 63 can be kept at atmospheric pressure or at a pressure slightly less than atmospheric pressure. In either of these states, the laser light 70 is emitted from a laser machining head (not shown) and directed onto the outside surface of the hollow workpiece 66. Dust (a plume) 72 is created by this machining.

Until the through-hole 75 is formed, in cases in which gas cannot escape from the irradiation chamber 63 as shown in FIG. 8(b), machining imposes a load on the transparent plate 43 or an airtight component when pressure is increased by too much. When pressure is increased by too much, air stirs up the dust 72, and there is a danger that the dust 72 will not be removed from the location to be machined and the dust 72 will block the laser light 70. In other words, machining is more efficient when the pressure is not too great.

When the through-hole 75 is formed as shown in FIG. 8(c), the laser light 70 collides with the filler 65. This collision allows the filler 65 to absorb the energy of the laser light 70. The internal peripheral surface 76 can be prevented from being irradiated by the laser light 70 due to the energy being absorbed by the filler 65.

The filler 65 irradiated by the laser light 70 is subjected to vibration by the vibrating mechanism 56. The control device 80 (FIG. 6) controls the vibrating mechanism 56 so as to adjust the vibration frequency and amplitude. For example, the vibration frequency is 30 kHz to 100 kHz, and the amplitude is 5 μm to 30 μm. The filler 65 is moved by this vibration, and the location irradiated by the laser light 70 can be changed in small increments.

Specifically, under these vibrating conditions, the rotating action can be performed while moving upward or downward by about 0.1 mm in the vertical direction in FIG. 8(c). It is possible to disperse the damage caused by the laser light 70 and to prolong the life of the filler 65 by ensuring that the location irradiated by the laser light 70 is not focused in one location on the filler 65.

When machining by the laser light 70 proceeds, the filler 65 is formed as shown in FIG. 8(c), a valve 77 is then closed, and the control device 80 controls the expulsion means 49 so as to stop. The dust 72 is recovered by the low-pressure means 64 after passing through the hole. After the hole is formed, the dust 72 created by the laser light 70 irradiation is recovered by the low-pressure means 64, and the dust 72 does not collect in the vicinity of the through-hole 75.

In the state in FIG. 8(a), the air pressure in the hollow part of the workpiece formed by the internal peripheral surface 76 is controlled so as to be less than the outside of the wall 68 of the workpiece. When the through-hole 75 is formed as shown in FIG. 8(c), the pressure difference causes air to flow through the hollow part of the workpiece as shown by the arrows, and the dust 72 is drawn out together with this flow by the low-pressure means.

When the valve 77 is switched, the air pressure in the irradiation chamber 63 becomes higher than the state in FIG. 8(a), the pressure difference between the air pressure in the irradiation chamber 63 and the air pressure in the hollow part increases further, and air flows even more smoothly through the hollow part of the workpiece as shown by the arrows in FIG. 8(c). The dust 72 can be prevented from re-adhering in the vicinity of the through-hole 75 and the operation can be made more efficient.

After the through-hole 75 has been formed, the expulsion function of the expulsion means 49 is halted. The air flow thereby consists only of air flowing from the gas supply means 45 toward the low-pressure means 64. The dust 72 can be efficiently expelled to the exterior by using a single air flow for expelling the dust 72.

The vibration frequency at which the vibrating mechanism 56 vibrates is 30 kHz to 100 kHz, and the amplitude of the vibration frequency is 5 μm to 30 μm. The size of the filler 65 is 30 μm to 20 mm. At this size, a space large enough for the filler to vibrate within the hollow part 67 is created in cases in which a fuel injection nozzle is used as the workpiece 66. It is also possible to prolong the life of the filler 65 because the filler 65 can be vibrated efficiently by vibrating under the vibrating conditions previously described.

In cases in which no filler is used as shown in FIG. 8(d), the laser light 70 strikes the internal peripheral surface 76 of the workpiece 66, and this portion is removed.

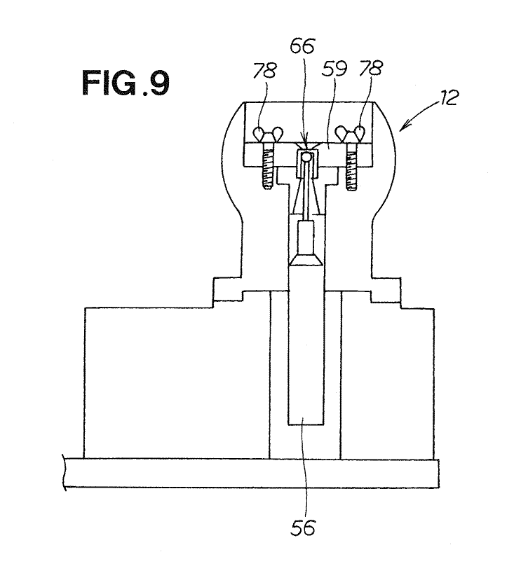

FIG. 9 describes a workpiece-supporting member 12 according to a second embodiment of the present invention.

Threaded bolts 78, 78 are used in the clamp mechanism as shown in FIG. 9. The clamp mechanism can be made with a simple configuration in cases in which the threaded bolts 78, 78 are used. Even when such a clamp mechanism is used, the effects of the present invention are obtained in that the internal peripheral surface can be prevented from being irradiated with laser light due to the energy being absorbed by the filler.

The hole-forming machine according to the present invention was applied to a fuel injection nozzle in the embodiments, but can also be applied to other machine components and the like if the portion has a thin through-hole formed, and the application of the present invention is not limited to these examples.

The hole-forming machine of the present invention is suitable for forming holes for fuel injection nozzles.

Obviously, various minor changes and modifications of the present invention are possible in light of the above teaching. It is therefore to be understood that within the scope of the appended claims the invention may be practiced otherwise than as specifically described.

What is claimed is:

1. A hole-forming machine for directing laser light (70) from an exterior of a hollow workpiece (66) into a hollow part (67) of the workpiece to thereby form a through-hole (75) in a wall (68) of the workpiece, the hole-forming machine comprising:
a filler (65) being unmeltable by the laser light and filled in the hollow part;
a vibrating mechanism (56) disposed to be in contact with the filler for causing the filler to vibrate;
pressure-reducing means (64) connected with the hollow part for making an air pressure in the hollow part less than that outside the wall;
an irradiation chamber (63) formed in such a manner as to close the irradiation part for leading the laser light into a part of the workpiece to be irradiated with the laser light;
gas supply means (45) connected with the irradiation chamber for supplying compressed gas into the irradiation chamber;
expulsion means (49), having a distal end (48) extending into the irradiation chamber, for expelling gas in the irradiation chamber, including dust created by the laser light irradiation, to outside of the irradiation chamber; and
a control device (80) for controlling the vibrating mechanism, the low-pressure means, the gas supply means and the expulsion means.

2. The hole-forming machine of claim 1, further comprising a workpiece-rotating table (27) for turnably supporting the workpiece, the workpiece-rotating table having an axis (28) passing through the workpiece.

3. The hole-forming machine of claim 1, wherein the control device controls an air pressure in the irradiation chamber such that the air pressure becomes greater than the air pressure in the hollow part and equal to or less than atmospheric pressure until the through-hole is formed.

4. The hole-forming machine of claim 1, wherein the control device controls the expulsion means so as to stop an expulsion function thereof after the through-hole has been formed.

5. The hole-forming machine of claim 1, wherein the filler has a diameter of 30 μm to 20 mm, the vibrating mechanism vibrates at a vibration frequency of 30 hKz to 100 kHz, and the amplitude of the vibration frequency is 5 μm to 30 μm.

6. A hole-forming machine for directing laser light (70) from an exterior of a hollow workpiece (66) into a hollow part (67) of the workpiece to thereby form a through-hole (75) in a wall (68) of the workpiece, the hole-forming machine comprising:
a filler (65) being unmeltable by the laser light and filled in the hollow part;
a vibrating mechanism (56) disposed to be in contact with the filler for causing the filler to vibrate; and
a workpiece-clamping mechanism (11) for securing the workpiece in place.

7. The hole-forming machine of claim 6, further comprising low-pressure means (64) connected with the hollow part for making the air pressure in the hollow part lower than that outside the wall.
